(19) United States
(12) Patent Application Publication
(10) Pub. No.: US 2007/0024256 A1
(43) Pub. Date: Feb. 1, 2007

(54) SWITCH-MODE MULTIPLE OUTPUTS DCDC CONVERTER

(76) Inventor: Yi-Chung Chou, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/161,207

(22) Filed: Jul. 27, 2005

(51) Int. Cl. G05F 1/00

(52) U.S. Cl. 323/268

(57) ABSTRACT

An integrated converter for converting a DC power source into multiple DC output voltages is provided. In the converter, a voltage regulator is selectively coupled to the power source. A control module outputs a timing signal based on a buck/boost signal. A voltage bucking/boosting module bucks or boosts the power source based on the timing signal. When the buck/boost signal indicates a buck operation, the voltage regulator is operably coupled to the power source to generate an output voltage, and the voltage bucking/boosting module bucks the generated output voltage to generate another output voltage.

### BACKGROUND OF THE INVENTION

1. Field of Invention

The present invention relates to a switch-mode multiple outputs DC (direct current)-to-DC converter. More particularly, the present invention relates to a DCDC converter with integrated boost converter/buck converter/voltage regulator.

2. Description of Related Art

Power supplies are known to take one voltage level and convert it to one or more different voltage levels and may be designed using a variety of topologies. For example, a power supply may be a switchboard power supply. A switch mode power supply may be implemented using one of many switch-mode topologies. For example, a switch-mode power supply may be implemented as a buck converter, or a boost converter.

Typically, if a switch-mode power supply is needed for lower power applications, it will include a buck or boost converter. Generally, a buck converter produces an output voltage that is less than the input voltage while a boost converter produces an output voltage that is greater than the input voltage. Thus, in low power applications such as portable electronic devices, a buck or boost converter is generally utilized depending on the voltage of the power source and the voltage needed to power the circuitry of the portable electronic device.

For example, a portable electronic device may be designed to be powered from a lithium battery that produces a supply between 4.2 volts and 3.0 volts while CMOS integrated circuits in the device requiring a supply of 1.8 volts to 2.5 volts. In this example, a buck converter would be utilized to step down the battery voltage to a controlled 1.8 or 2.5 volts. If, however, the same portable electronic device were designed to be powered from a 1.5 volts battery, the device would include a boost converter to step up the 1.5 volts to 1.8 or 2.5 volts. Clearly, the selection of a power source and the selection of circuitry are made by the designer of the portable electronic device. Therefore, the manufacturing of the integrated circuits should support either choice of the designer of the device can make to power the system.

FIG. 1 shows a conventional integrated buck/boost converter for converting a power source 11 (Vin) into two DC outputs (Vo1 and Vo2). A control module 12 senses a buck/boost signal 22 from a buck/boost determination module 14 to determine buck or boost mode of the converter. The buck/boost determination module 14 controls closed/open states of switches S1˜S4 via a boost mode signal 24 and a buck mode signal 26. The control module 12 also generates timing control signals 28/30/32/34 to cause transistors M1/M2/M3/M4 turned on or off.

If Vin from the power source 11 is larger than both Vo1 and Vo2, the buck/boost signal 22 indicates a buck mode. If Vin is lower than both Vo1 and Vo2, the buck/boost signal 22 indicates a boost mode. In the buck mode, the buck/boost determination module 14 causes switches S3 and S4 to be closed and switches S1 and S2 to be open and Vin is bucked via transistors M1/M2/M3/M4 and the inductor L1 to generate Vo1 and Vo2. In the boost mode, the buck/boost determination module 14 causes switches S3 and S4 to be open and switches S1 and S2 to be closed and Vin is boosted via transistors M1/M2/M3 and the inductor L1 to generate Vo1 and Vo2 while the transistor M4 does not work.

To minimize the impact of multiple system level designs, many manufacturers implement both a buck and boost converter associated with the same circuitry to provide for flexibility in the choice of power sources. While this technique reduces the complexity of managing multiple system level designs since one design may be used in multiple applications, it requires additional circuitry and accordingly, additional circuitry increases the cost to produce a device.

Therefore, a need exists for a total solution that can provide the flexibility to implement either a buck or a boost converter in multiple applications and minimizes the need for additional circuitry.

### SUMMARY OF THE INVENTION

In one aspect of the invention, boost/buck converter/LDO is integrated into a multiple outputs DCDC converter and the whole converter is area-reduced.

In one embodiment of the invention, an integrated converter for converting a power source into multiple output voltages is provided. The integrated converter includes a voltage regulator, selectively coupled to the power source; a control module, outputting a timing signal based on a buck/boost signal; and a voltage bucking/boosting module, bucking or boosting the power source based on the timing signal. When the buck/boost signal indicates a buck operation, the voltage regulator is operably coupled to the power source to generate a first output voltage, and the voltage bucking/boosting module bucks the generated first output voltage to generate a second output voltage.

In another embodiment of the invention, a buck/boost determination module senses potential of the power source to generate the buck/boost signal. Or, a pin provides the buck/boost signal by receiving external commands.

In still another embodiment of the invention, the voltage bucking/boosting module comprises an inductor, selectively coupled to the power source; a first transistor, having a first drain coupled to the inductor, a first gate receiving the timing signal from the control module and a first source grounded; a second transistor, having a second drain coupled to the inductor, a second gate receiving the timing signal from the control module and a second source selectively coupled to the second output voltage; and a third transistor, having a third drain coupled to the inductor, a third gate receiving the timing signal from the control module and a third source coupled to the first output voltage.

In yet another embodiment of the invention, a method of converting DC external power source into multiple DC output voltages is provided. In the method, it is determined whether a buck/boost signal is indicating a buck operation or a boost operation based on determining potential of the power source or an external command received by a pin. When the buck/boost signal is indicating a buck operation, the external power source is operably regulated into a first DC output voltage. The first regulated DC output voltage is bucked into a second DC output voltage.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a conventional DCDC converter integrated with buck/boost converter.

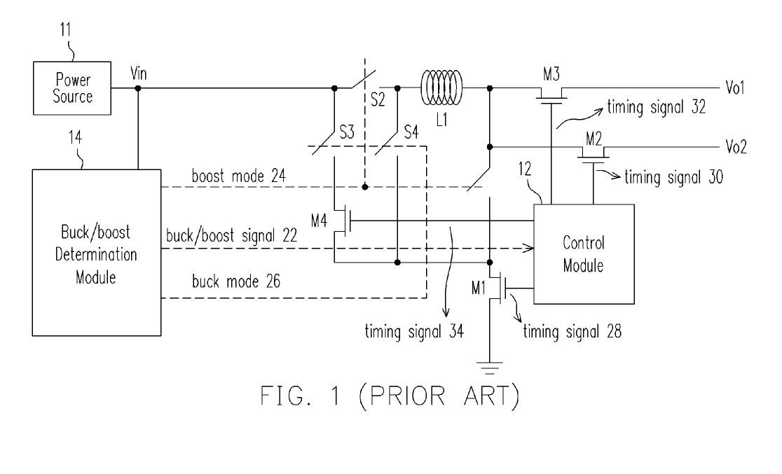

FIG. 2 is a block diagram of an integrated DCDC converter according to a preferred embodiment of the present invention.

FIGS. 3A and 3B are timing charts suitable for controlling transistors in FIG. 2.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

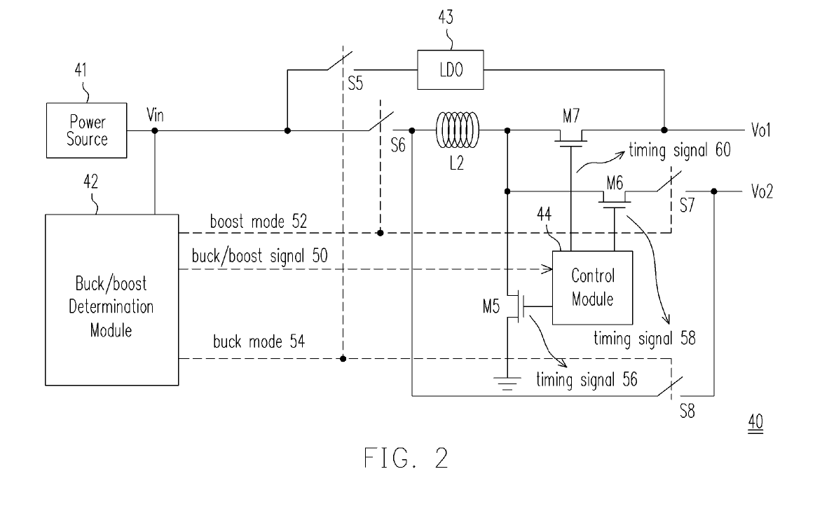

FIG. 2 is a block diagram of an integrated DCDC converter 40 according to a preferred embodiment of the present invention. A power source 41 is, for example but not limited to, an AC/DC adaptor, a USB (Universal Serial Bus) port on a personal computer or a notebook computer, a lithium battery or a dry battery. In FIG. 2, Vo1 is larger than Vo2.

As shown in FIG. 2, the DCDC converter 40, sourced from the power source 41, includes a buck/boost determination module 42, an LDO (Low Drop-Out voltage regulator) 43, a control module 44, an inductor L2, switches S5˜S8 and transistors M5˜M7.

The buck/boost determination module 42 may determine whether the converter is to be operated in a buck mode or a boost mode. For example, if the buck/boost determination module 42 senses that Vin from the power source 41 is larger than Vo1, the converter 40 may be operated in a buck mode, and vice versa. The buck/boost signal 50, output from the buck/boost determination module 42 and received by the control module 44, would be selected for a buck or boost configuration based on the Vin sense result.

The LDO 43 is to be operated in a buck mode operation but not if in a boost mode operation.

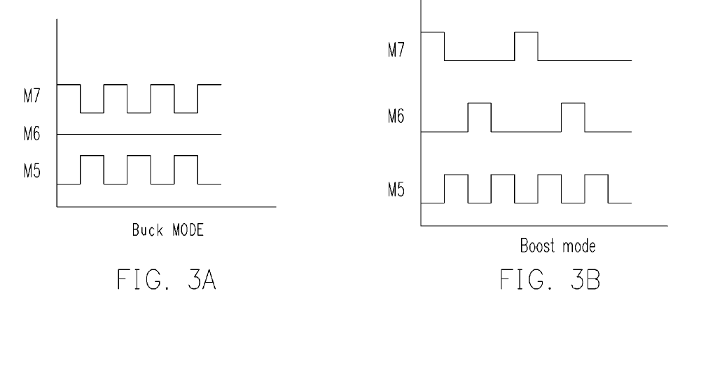

The control module 44 receives the buck/boost signal 50 from the buck/boost determination module 42 to control ON/OFF of the transistors M5˜M7 via timing signals 56˜60. The timing signals 56˜60 of the transistor M5˜M7 are shows in FIGS. 3A˜3B in buck mode and boost mode, respectively.

The switch S5 is coupled between the power source 41 and the LDO 43. The switch S6 is coupled between the power source 41 and the inductor L2. The switch S7 is coupled between a source of the transistor M6 and Vo2. The switch S8 is coupled between the inductor L2 and Vo2.

The closed/open states of the switches S5˜S8 is controlled by a boost mode signal 52 and a buck mode signal 54 from the buck/boost determination module 42. In a boost mode, switches S6 and S7 are closed and switches S5 and S8 are open. In a buck mode, switches S6 and S7 are open and switches S5 and S8 are closed.

The transistor M5 has a gate receiving the timing signal 56 from the control module 12, a source grounded and a drain coupled to the inductor L2. The transistor M6 has a gate receiving the timing signal 58 from the control module 12, a source coupled to the switch S7 and a drain coupled to the inductor L2. The transistor M7 has a gate receiving the timing signal 60 from the control module 12, a source coupled to Vo1 and a drain coupled to the inductor L2.

If the buck/boost signal 50 indicates a buck mode of the converter 40, in other words, Vin is larger than both Vo1 and Vo2, switches S5 and S8 are closed while switches S6 and S7 are open. In the buck mode, the transistor M6 is not to be operated. By closing the switch S5, the LDO 43 is coupled to the power source 41 and Vin is down regulated by the LDO 43 to generate Vo1. By closing the switch S8, the inductor L2 is coupled to Vo2. Vo1, generated by the LDO 43, generates Vo2 via the transistor M7, the inductor L2 and the closed switch S8. In other words, the converter 40 bucks Vo1 into Vo2. In buck mode, the timing signals 56˜60, coupled to the transistors M5˜M7, are shown in FIG. 3A. During the high period of the timing signals 60, the transistor M7 is turned on, electrical energy from Vo1 is stored in the inductor L2 and the voltage level of Vo2 is slightly raised. During the low period of the timing signals 60, the transistor M7 is turned off, only electrical energy stored in the inductor L2 is output to Vo2 and the voltage level of Vo2 is slightly lowered. Furthermore, Vo1 has smaller ripples because it is generated from the LDO 43.

If the buck/boost signal 50 indicates a boost mode of the converter 40, in other words, Vin is smaller than both Vo1 and Vo2, switches S5 and S8 are open while switches S6 and S7 are closed. Because the switch S5 is open, the LDO 43 is not coupled to the power source 41 and accordingly Vo1 is generated from a boost of Vin. By closing the switch S6, the inductor L2 is coupled to the power source 41. By closing the switch S7, the transistor M6 is coupled to Vo2, in other words, the transistor M6 is to be operated in boost mode. During boost mode, Vin is boosted to generate Vo1 via the inductor L2 and the transistor M7 and to generate Vo2 via the inductor L2 and the transistor M7. In boost mode, the timing signals 56˜60 are shown in FIG. 3B. During the high period of the timing signals 60, the transistor M7 is turned on, electrical energy from the power source 41 is stored in the inductor L2 and then transmitted to Vo1 and accordingly, the voltage level of Vo1 is slightly raised. During the low period of the timing signals 60, the transistor M7 is turned off, no electrical energy stored in the inductor L2 is output to Vo1 and accordingly, the voltage level of Vo1 is slightly lowered. Similarly, during the high period of the timing signals 58, the transistor M6 is turned on, electrical energy from the power source 41 is stored in the inductor L2 and then transmitted to Vo2 and accordingly, the voltage level of Vo2 is slightly raised. During the low period of the timing signals 58, the transistor M6 is turned off, no electrical energy stored in the inductor L2 is output to Vo2 and accordingly, the voltage level of Vo2 is slightly lowered.

In an alternate DCDC converter, the buck/boost signal 50 may be provided via a pin. For example, if the pin is held logic high, a buck operation is selected and when held low, a boost operation is selected, or vice versa. Besides, the embodiment is applicable to multiple outputs DCDC converter by proper modification, for example, via more appropriate transistors and timing signals thereof.

In a still another DCDC converter according to another embodiment of the invention, the boost mode signal 52 and the buck mode signal 54 are provided by the control module 44, instead of by the buck/boost determination module 42.

In a yet another embodiment according to the invention, a method of converting DC input voltage into multiple DC output voltages is provided. It is determined whether a buck/boost signal is indicating buck operation or boost operation, by a buck/boost determination module which generates the buck/boost signal in response to sensing potential of DC input voltage. Or, the buck/boost signal may be provided by a pin receiving an external command. When the buck/boost signal is indicating buck operation, the DC input voltage is operably regulated into a DC output voltage by a voltage regulator, for example but not limited to, an LDO. The first DC output voltage is bucked into a second DC output voltage by a combination of a control module, transistors and switches.

The LDO 43 may be shared by other circuitry to further reduce layout area of whole circuitry.

The DCDC converter according to the embodiment of the invention is suitable for portable electronic device. The above discussion has presented an apparatus for a highly integrated buck/boost/LDO converter module. With minimal additional circuitry, the present invention provides flexibility to designers of portable electronic devices to select various different types of power sources, i.e. batteries or adaptors, to source integrated circuits inside the portable electronic devices.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. An integrated converter, for converting a power source into multiple output voltages, comprising:
a voltage regulator, selectively coupled to the power source;
a control module, outputting a timing signal based on a buck/boost signal;
a voltage bucking/boosting module, bucking or boosting the power source based on the timing signal;
wherein when the buck/boost signal indicates a buck operation, the voltage regulator is operably coupled to the power source to generate a first output voltage, and the voltage bucking/boosting module bucks the generated first output voltage to generate a second output voltage.

2. The integrated converter of claim 1, further comprising a buck/boost determination module sensing potential of the power source to generate the buck/boost signal.

3. The integrated converter of claim 1, further comprising a pin to provide the buck/boost signal in response to an external command.

4. The integrated converter of claim 1, wherein the voltage regulator comprises a low drop-out voltage regulator.

5. The integrated converter of claim 1, wherein the voltage bucking/boosting module comprises:
an inductor, selectively coupled to the power source;
a first transistor, having a first drain coupled to the inductor, a first gate receiving the timing signal from the control module and a first source grounded;
a second transistor, having a second drain coupled to the inductor, a second gate receiving the timing signal from the control module and a second source selectively coupled to the second output voltage; and
a third transistor, having a third drain coupled to the inductor, a third gate receiving the timing signal from the control module and a third source coupled to the first output voltage.

6. A method of converting DC input voltage into multiple DC output voltages, comprising:
determining whether a buck/boost signal is indicating a buck operation or a boost operation;
when the buck/boost signal is indicating a buck operation, operably regulating the DC input voltage into a first DC output voltage; and
bucking the first regulated DC output voltage into a second DC output voltage.

7. The method of claim 6, further comprising generating the buck/boosting signal based on determining potential of the power source.
